(19) United States
(12) Patent Application Publication
(10) Pub. No.: US 2017/0125803 A1
(43) Pub. Date: May 4, 2017

(54) ELECTRODE MATERIAL FOR A LITHIUM ION BATTERY AND THE METHOD OF PREPARING THE SAME

(71) Applicants: James Ching-Hua LI, Taichung City (TW); GET GREEN ENERGY CORP., LTD., Taichung City (TW)

(72) Inventors: Kuo-Feng CHIU, Taichung City (TW); Po-Nien LAI, Taichung City (TW); Shin-Lee LIU, Taichung City (TW); Chun-Han LEE, Taichung City (TW)

(21) Appl. No.: 15/403,825

(22) Filed: Jan. 11, 2017

Related U.S. Application Data
(63) Continuation-in-part of application No. PCT/US2015/059946, filed on Nov. 10, 2015.

(30) Foreign Application Priority Data
Nov. 13, 2014 (TW) 103139416

(51) Int. Cl. H01M 4/36; H01M 4/58; H01M 4/62; H01M 10/0525

(52) U.S. Cl. CPC H01M 4/366; H01M 10/0525; H01M 4/5825; H01M 4/625; H01M 4/622

(57) ABSTRACT

An electrode material for a lithium ion battery includes conductive active particles and an ionic cover layer covering the active particles. The ionic cover layer includes a matrix of functional group-substituted polyaryletherketone and graphene particles dispersed in the matrix. A method for preparing the electrode material and an electrode including the electrode material are also disclosed.

### CROSS-REFERENCE TO RELATED APPLICATION

This application is a continuation-in-part of International Application No. PCT/US15/59946, titled “ELECTRODE MATERIAL FOR A LITHIUM ION BATTERY AND THE METHOD OF PREPARING THE SAME,” filed on Nov. 10, 2015, which claims priority of Taiwanese Patent Application No. 103139416, filed on Nov. 13, 2014.

### FIELD

The disclosure relates to an electrode material for a lithium ion battery, more particularly to an electrode material including a matrix of functional group-substituted polyaryletherketone and graphene particles dispersed in the matrix.

### BACKGROUND

Graphene is currently the thinnest but also the hardest nanomaterial in the world. Graphene has an exceptionally large thermal conductivity of 5,300 Wm·⁻¹·K⁻¹and a low resistivity of 10 ⁻⁶Ω·cm, and is thus suitable for being used as an electrode material.

Since graphene has poor dispersibility and is easy to aggregate, a dispersant is required for facilitating dispersion of graphene in a super capacitor or an electrode material. Examples of the dispersant include sodium dodecyl benzene sulfonate (SDBS), sodium dodecyl sulfate (UDS), etc. However, the electrode material containing the dispersant has poor conductivity and electrochemical activity. As such, when used in lithium ion battery, the capacity of the lithium ion battery may drop dramatically and the operating voltage may be significantly reduced during charging and discharging operations.

### SUMMARY

Therefore, an object of the disclosure is to provide an electrode material that can alleviate at least one of the drawbacks of the prior arts.

According to one aspect of the disclosure, there is provided an electrode material for a lithium ion battery. The electrode material includes conductive active particles and an ionic cover layer covering the conductive active particles. The ionic cover layer includes a matrix of functional group-substituted polyaryletherketone and graphene particles dispersed in the matrix.

According to another aspect of the disclosure, there is provided a method of preparing an electrode material for lithium ion battery. The method includes: dissolving functional group-substituted polyaryletherketone into a solvent to form a functional group-substituted polyaryletherketone solution; adding conductive active particles and graphene particles into the functional group-substituted polyaryletherketone solution to form a mixture slurry; and drying the mixture slurry to form the electrode material.

According to yet another aspect of the disclosure, there is provided an electrode for a lithium ion battery. The electrode includes a substrate and a layered structure formed on the substrate and including the aforementioned electrode material.

### BRIEF DESCRIPTION OF THE DRAWINGS

Other features and advantages of the disclosure will become apparent in the following detailed description of the embodiments with reference to the accompanying drawings, of which:

FIG. 1 is a SEM diagram illustrating the surface morphology of an electrode of Example;

FIG. 2 is a plot of specific capacity vs. potential for a lithium ion battery of each of Example and Comparative Example;

FIG. 3 is a plot of the number of cycles vs. final capacity, illustrating results of a charge-discharge cycle test for the lithium ion batteries of Example and Comparative Example;

FIG. 4 is a plot of the number of cycles vs. capacity retention rate, illustrating results of the charge-discharge cycle test for the lithium ion batteries of Example and Comparative Example; and

FIG. 5 is a perspective view of an embodiment of an electrode for a lithium ion battery according to the disclosure.

### DETAILED DESCRIPTION

The embodiment of an electrode material for a lithium ion battery according to the disclosure includes conductive active particles and an ionic cover layer covering the conductive active particles. The ionic cover layer includes a matrix of functional group-substituted polyaryletherketone and graphene particles dispersed in the matrix.

The functional group-substituted polyaryletherketone adsorbs graphene particles through interaction between n bonds of the benzene ring structures and the graphene particles. Electrostatic repulsion forces are generated among substituted functional groups of the functional group-substituted polyaryletherketone, and are advantageous to induce dispersion of the graphene particles in the matrix of the functional group-substituted polyaryletherketone. In addition, the ionic cover layer exhibits a relatively strong adhesion to the conductive active particles, and can replace binders and/or dispersants used in the conventional electrode materials. Furthermore, the ionic cover layer may have a three-dimensional network structure that can facilitate movement or transport of electrons and ions, resulting in resistance reduction of the electrode material.

Preferably, polyaryletherketone of the functional group-substituted polyaryletherketone may be poly ether ketone (PEK), polyether ether ketone (PEEK), polyetherketoneketone (PEKK), poly(ether ether ketone ketone) (PEEKK), polyetherketoneetherketoneketone (PEKEKK), or combinations thereof.

Preferably, examples of the functional group-substituted polyaryletherketone include SO₃⁻-substituted polyaryletherketone and NO₂-substituted polyaryletherketone. More preferably, the functional group-substituted polyaryletherketone is SO₃⁻-substituted polyaryletherketone.

Preferably, the conductive active particles are made from a material, LiCoO₂, LiNiO₂, LiMn₂O₄, LiMnCoO₄, LiCc_{0.3}Ni_{0.3}Mn_{0.3}O, LiCoPO₄, LiMnCrO₄, LiNiVO₄, LiMnOrO₄, LiMn_{1.5}Ni_{0.5}O₄, LiCoVO₄, LiFePO₄, Si, SiSnₓ, Sn, SnO, SnO₂, Ge, Ga, derivatives thereof, alloys thereof, or combinations thereof.

Preferably, the conductive active particles are in an amount ranging from SO to 95 wt %, the functional group-substituted polyaryletherketone is in an amount ranging from 0.5 to 15 wt %, and the graphene particles are in an amount ranging from 0.1 to 5 wt %, based on the total weight of the electrode material.

Preferably, the graphene particles have a flake-like shape that defines a length and a thickness. The thickness of the graphene particles ranges from 0.35 nm to 10 nm, and the length of the graphene particles ranges from 20 nm to 2000 nm.

A method of preparing the embodiment of the electrode material includes: dissolving a functional group-substituted polyaryletherketone into a solvent to form a functional group-substituted polvaryletherketone solution; adding conductive active particles and graphene particles into the functional group-substituted polyaryletherketone solution to form a mixture slurry; and drying the mixture slurry to form the electrode material.

Preferably, the functional group-substituted polyaryletherketone is prepared by reacting polyaryletherketone with sulfide or nitride in a solution.

Preferably, the functional group of the functional group-substituted polyaryletherketone is in an amount ranging from 5 to 20 wt % based on the total weight of the functional group-substituted polyaryletherketone.

Preferably, examples of the solvent include dimethyl sulfoxide (DMSO), dimethyl formamide (DMF), and tetrahydrofuran (THF).

Preferably, drying the mixture slurry is conducted at a temperature ranging from 40 to 200° C.

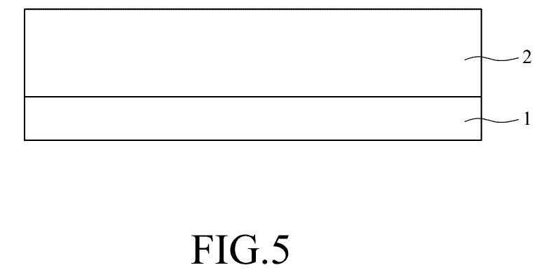

As shown in FIG. 5, the embodiment of an electrode for a lithium ion battery according to the disclosure may include a substrate 1 and a layered structure 2 that is formed on the substrate 1 and that includes a conductive material and the aforementioned electrode material.

There is no particular limitation to the substrate 1 for the electrode. In certain embodiments, the substrate 1 may be copper foil, aluminum foil, nickel foil, titanium foil or stainless steel foil.

In certain embodiments, the layered structure further includes a binder to bond the conductive material and the electrode material.

In certain embodiment, the thickness of the layered structure ranges from 200 nm to 200 μm.

Preferably, the conductive material includes a carbonaceous material. The carbonaceous material includes a plurality of carbonaceous particles. Examples of the carbonaceous material include, but are not limited to, soft carbons (low temperature calcinated or sintered carbon), hard carbons (pyrolytic carbon), amorphous carbon materials, graphite particles, conductive carbon powder, and combinations thereof.

In certain embodiments, the binder is made from a material, e.g., polyvinylidene chloride, polyvinylidene fluoride (PVDF), polyfluorovinylidene, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated ethylene-propylene-diene polymer, styrene butadiene rubber (SBR), fluorine rubber, or combinations thereof.

The following examples are provided to illustrate certain embodiments of the disclosure, and should not be construed as limiting the scope of the disclosure.

### EXAMPLES

### Example (EX)

Polyaryletherketone was added in and mixed with a solution containing sulfide ions under 50 to 80° C. to undergo sulfonation, followed by washing with iced water and then curing to obtain the sulfonated polyaryletherketone.

The sulfonated polyaryletherketone was dissolved in dimethyl sulfoxide (DMSO), followed by adding graphene under stirring first, then adding LiFePO₄ (serving as the conductive active particles) and carbon black (having a particle size ranges from 5 to 10 μm and serving as the conductive material) into the mixture, and stirring evenly to form a mixture slurry. The solid matter of the mixture slurry thus formed includes 9.8 wt % carbon black, 0.2 wt % graphene, 10 wt % sulfonated polyaryletherketone, and 80 wt % LiFePO₄.

A disc-shaped copper foil having an area of 1.33 cm² was prepared to serve as a substrate. The substrate was cleaned to remove oxides and organic pollutants thereon. The cleaned substrate was immersed in a mixture of acetone and ethanol, and was subjected to sonication to remove oil and other pollutants thereon. 3 mg of the mixture slurry was applied to the disc-shaped copper foil to form a layer having a thickness of 5 to 150 μm, followed by drying under 40 to 200° C. in an oven to form an electrode.

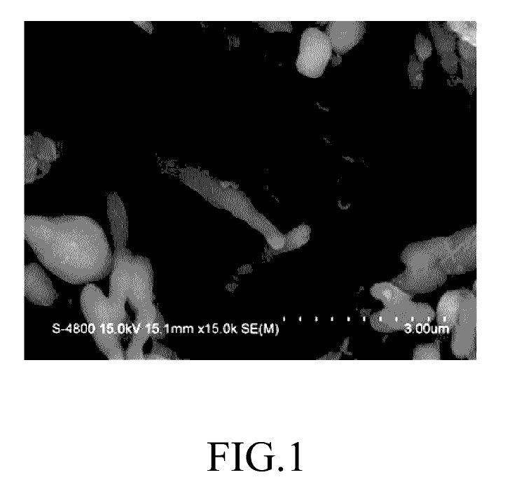

The SEM diagram of the electrode is shown in FIG. 1.

The electrode was used as a working electrode, and was assembled with a lithium-based electrode (serving as a counter electrode), a polypropylene (PP) isolation membrane, and a LiPF₆ electrolyte in a conventional manner to form a CR2032 type lithium ion battery.

### Comparative Example (CE)

Graphene, carbon black (having a particle size ranges from 5 to 10 μm and serving as the conductive material), LiFePO₄ (serving as the conductive active particles), sodium dodecyl benzene sulfonate (SDBS, serving as a dispersant), and polyvinylidene difluoride (PVDF, serving as a binder) were dissolved in N-Methyl-2-pyrrolidone (NMP), followed by stirring evenly to form a mixture slurry. The solid matter of the mixture slurry included 9.8 wt % carbon black, 0.2 wt % graphene, 2 wt % PVDF, 8 wt % polyvinylidene difluoride, and 80 wt % LiFePO₄.

A disc-shaped copper foil having an area of 1.33 cm² was prepared to serve as a substrate. The substrate was cleaned to remove oxides and organic pollutants thereon. The cleaned substrate was immersed in a mixture of acetone and ethanol, and was subjected to sonication to remove oil and other pollutants thereon. 3 mg of the mixture slurry was applied to the disc-shaped copper foil to form a layer having a thickness of 5 to 150 μm, followed by drying under 40 to 200° C. in an oven to form an electrode.

The procedures and conditions in preparing the CR2032 type lithium ion battery of Comparative Example were similar to those of Example.

### Performance Test

### Specific Capacity v. Potential Test

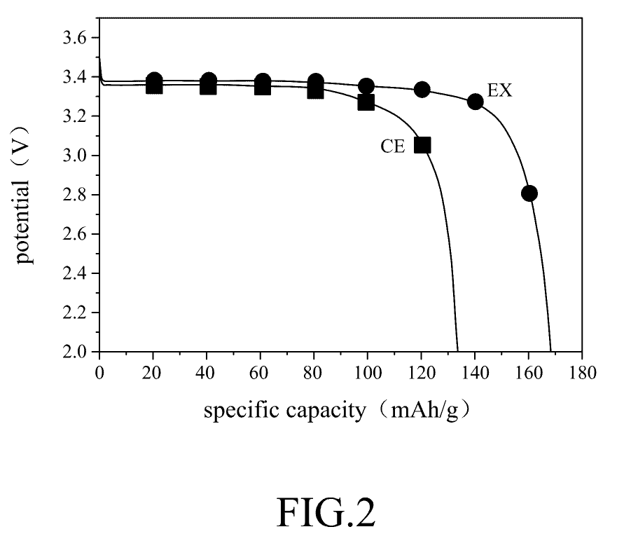

The relation of specific capacity vs. potential for the lithium ion battery of each of Example and Comparative Example was obtained (see FIG. 2). The capacity values under different potentials were measured at the 1^{st} cycle of the charge-discharge operation under 25° C. The test results show that the capacity of the lithium ion battery of Example is significantly higher than that of Comparative Example.

### Charge-Discharge Cycle Test under Different Charge-Discharge Rates

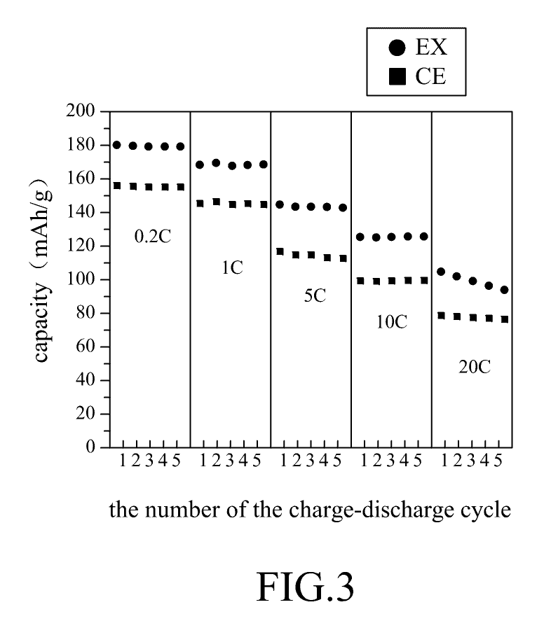

The lithium ion battery of each of Example and Comparative Example was subjected to a charge-discharge cycle test that was operated within a voltage between 2.0V and 3.6V at different charge-discharge rates of 0.2 C (Coulomb), 1 C, 5 C, 10 C and 20 C (each of the values represents the charge rate, and the discharge rate as well) under 25° C. FIG. 3 shows the test results of the capacity versus the number of the charge-discharge cycle under different charge-discharge rates for the lithium ion battery of each of Example and Comparative Example.

The test results show that the capacity of the lithium ion battery of Example is significantly higher than that of Comparative Example, and that the lithium ion battery of Example can be operated at a larger current as compared to that of Comparative Example.

### Charge-Discharge Cycle Test under Fixed Charge-Discharge Rate

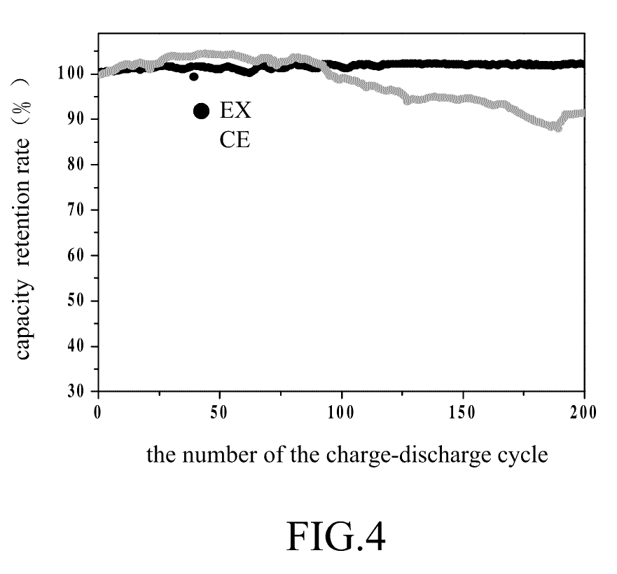

The lithium ion battery of each of Example and Comparative Example was subjected to a charge-discharge cycle test that was operated within a voltage between 2.0V and 3.6V at a charge-discharge rate of 1 C under 25° C. FIG. 4 shows that the test results of the capacity retention rate versus the number of charge-discharge cycle for the lithium ion battery of each of Example and Comparative Example.

The test results show that after 200 cycles of the charge-discharge operation under a charge-discharge rate of 1 C, the capacity of the lithium ion battery of Example is more stable than that of Comparative Example, and that the capacity retention rate of Example is about 100% as compared to 87% for Comparative Example.

### Zeta Potential

The zeta potential of the mixture slurry in each of Example and Comparative Example was determined in a conventional manner. Each mixture slurry was injected into a sealed transparent container. The mixture slurry in the container was scanned with laser light having 532 nm to measure the electrophoretic mobility of particles in the mixture slurry. The measured electrophoretic mobility of the particles was then used to calculate the zeta potential of the mixture slurry.

The calculated zeta potential of the mixture slurry in Example was 54 mV, and was 13 mV for Comparative Example.

In order to meet the requirements of industries, the zeta potential of the mixture slurry is required to be more than 30 mV. The zeta potential will be more than 40 mV when the graphene in the mixture slurry is well dispersed.

The increase of the zeta potential of the mixture slurry from 18 mV (CE) to 54 mV (EX) shows that the graphene of the mixture slurry in Example was well dispersed as compared to Comparative Example, and that the functional group-substituted polyaryletherketone of the ionic cover layer can facilitate dispersion of graphene in the mixture slurry as compared to the dispersant used in Comparative Example.

In conclusion, with the inclusion of the ionic cover layer covering the active particles in the electrode material for a lithium ion battery of the present disclosure, the aforesaid drawback associated with the prior art can be alleviated.

While the present disclosure has been described in connection with what are considered the practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An electrode material for a lithium ion battery, comprising:
conductive active particles; and
an ionic cover layer covering said conductive active particles;
wherein said ionic cover layer includes a matrix of functional group-substituted polyaryletherketone and graphene particles dispersed in said matrix.

2. The electrode material as claimed in claim 1, wherein said polyaryletherketone of said functional group-substituted polyaryletherketone is selected from the group consisting of poly ether ketone, polyether ether ketone, polyetherketoneketone, poly (ether ether ketone ketone), polyetherketoneetherketoneketone, and the combinations thereof.

3. The electrode material as claimed in claim 1, wherein said functional group-substituted polyaryletherketone is selected from one of SO₃⁻-substituted polyaryletherketone and NO₂-substituted polyaryletherketone.

4. The electrode material as claimed in claim 1, wherein said functional group-substituted polyaryletherketone is SO₃⁻-substituted polyaryletherketone.

1. electrode material as claimed in claim 1, wherein said conductive active particles are made from a material selected from the group consisting of LiCoO₂, LiNiO₂, LiMn₂O₄, LiNnCoO₄, LiCoPO₄, LiMnCrO₄, LiNiVO₄, LiMnCrO₄, LiMn_{0.5}Ni_{0.5}O₄, LiCoVO₄, LiFePO₄, Si, SiSnₓ, Sn, SnO, SnO₂, Ge, Ga, derivative or alloy of the aforementioned compounds or elements, and combinations thereof.

6. The electrode material as claimed in claim 1, wherein said conductive active particles are in an amount ranging from 80 to 95 wt %, said functional group-substituted polyaryletherketone is in an amount ranging from 0.5 to 15 wt %, and said graphene particles are in an amount ranging from 0.1 to 5 wt %, based on the total weight of said electrode material.

7. The electrode material as claimed in claim 1, wherein said graphene particles have a flake-like shape that defines a length and a thickness, said thickness of said graphene particles ranging from 0.35 to 10 nm, said length of said graphene ranging from 20 to 2000 nm.

8. A method of preparing an electrode material for a lithium ion battery, the method comprising:
dissolving a functional group-substituted polyaryletherketone into a solvent to form a functional group-substituted polyaryletherketone solution;
adding conductive active particles and graphene particles into the functional group-substituted polyaryletherketone solution to form a mixture slurry; and
drying the mixture slurry to form the electrode material.

9. The method of claim 8, wherein the functional group-substituted polyaryletherketone is prepared by reacting polyaryletherketone with sulfide or nitride in a solution to form the functional group-substituted polyaryletherketone.

10. The method of claim 8, wherein the solvent is selected from the group consisting of dimethyl sulfoxide, dimethyl formamide, and tetrahydrofuran.

11. The method of claim 8, wherein the conductive active particles are in an amount ranging from 80 to 95 wt %, the functional group-substituted polyaryletherketone are in an amount ranging from 0.5 to 15 wt %, and the graphene particles are in an amount ranging from 0.1 to 5 wt %, based on the total weight of the electrode material.

12. The method of claim 8, wherein the polyaryletherketone of the functional group-substituted polyaryletherketone is selected from the group consisting of poly ether ketone, polyether ether ketone, polyetherketoneketone, poly(ether ether ketone ketone), polyetherketoneetherketoneketone, and combinations thereof.

13. The method of claim 8, wherein drying the mixture slurry is conducted at a temperature ranging from 40 to 200° C.

14. The method of claim 8, wherein the functional group-substituted polyaryletherketone is selected from one of SO₃⁻-substituted polyaryletherketone and NO₂-substituted polyaryletherketone.

15. An electrode for a lithium ion battery, comprising:
a substrate; and
a layered structure formed on said substrate and including a conductive material and said electrode material as claimed in claim 1.
